(19) United States
(12) Patent Application Publication
(10) Pub. No.: US 2010/0285698 A1
(43) Pub. Date: Nov. 11, 2010

(54) PROBE PIN COMPOSED IN ONE BODY AND THE METHOD OF MAKING IT

(76) Inventor: Hong-Dae Lee, Busan (KR)

Correspondence Address: LEXYOUME IP GROUP, LLC, 5180 PARKSTONE DRIVE, SUITE 175, CHANTILLY, VA, 20151, US

(21) Appl. No.: 12/811,399

(22) PCT Filed: Dec. 30, 2008
(86) PCT No.: PCT/KR08/07804

§ 371 Date: Jul. 1, 2010

(51) Int. Cl. H01R 4/48; H01R 43/16

(52) U.S. Cl. 439/786; 29/874

(57) ABSTRACT

The present invention relates to an integrally formed probe pin, more particularly, to the probe pin which enables both sides or one side of connecting port to connect the coil spring by cutting and bending the body as a part of the pin using the progressive die, to generate elasticity for testing smoothly. And the fabricating method of the probe pin comprising, cutting a body so that an upper contact part, a lower contact part, and an elastic spring part may be formed in one body; burning a coil spring for an elastic spring part to have the elastic force; molding a lower port for a lower contact part to be formed roundly; bending the elastic spring part to the inner side of the body; finishing that the upper contact part may be rolled smaller than an external diameter of the body and projected after molding the body roundly. The present invention provides the effect of reducing the fabricating time remarkably and lowering of the production cost due to needlessness of the fabricating time, in addition, mass production may be possible and it improves the electric characteristic by fabricating the probe pin in one body.

### TECHNICAL FIELD

The present invention relates to an integrally formed probe pin, more particularly, to the probe pin which enables both sides or one side of connecting port to connect the coil spring by winding the coil spring using a plate shape of material inside the progressive die after cutting and bending the body as a part of the pin using the progressive die, to thereby generate elasticity for testing smoothly.

In addition, the probe pin has relatively low resistance, for it is formed integrally and is maintained the same impedance to the transmitting line of electric signals.

### BACKGROUND ART

In general, a probe pin, on its own or with different sorts of pins, is widely used in test sockets for testing a semi-conductor chip package and a component formed on the wafer. Examples where the probe pin is used in the test socket are disclosed in Patent application No. 68258, ‘Socket for package’ filed in 1999, and Utility model application No. 31810, ‘Socket device for testing chip’ filed in 2001.

The probe pin 1 as such is illustrated in FIG. 1. Referring to FIG. 1, the probe pin 1 includes a sleeve 4 where an upper and lower hook jaws 2, 3 are formed toward the inside in the both ends, an upper contact part 5 and a lower contact part 6 where a part of the area is mounted inside of the sleeve 4 respectively, and a coil spring 7 mounted on the sleeve 4 that is interposed between the upper contact part 5 and the lower contact part 6.

The upper contact part 5 includes the upper body part 8 formed inside of the sleeve 4, and the upper contact pin 9 vertically prolonged and formed from the upper face of the upper body part 8. And the upper body part 8 is mounted on the sleeve 4 not to be forced to deviate by the hook jaw 2.

The lower contact part 6 has lower body part 10 formed inside of the sleeve 4, and the lower contact pin 11 vertically prolonged and formed from the lower face of the lower body part 10. And the lower body part 10 is mounted on the sleeve 4 not to be forced to deviate by the hook jaw 2.

The end portions of the upper and lower contact pins 9, 11 are always matched with the shape of the external connecting port.

For example, in case of using the probe pin 1 mounted in the test socket, the upper contact pin 9 is formed to get downward curve when the external connecting port of the semi-conductor chip package is a ball type.

In the conventional probe pin 1, the upper and lower contact part 5, 6 are slidable moving toward the opposite part inside the sleeve 4 when the pressure is applied to the upper and lower contact part 5, 6.

As described above, according to slidable moving of the upper and lower contact parts 5, 6, the coil spring 7 is contracts, therefore the upper and lower contact pin 9, 11 are elastically connected with a pair of external connecting ports. In a state that the upper and lower contact pin 9, 11 are elastically connected with a pair of external connecting ports, the electrical signal is transferred to the conducting path including the upper and lower contact parts 5, 6, and the sleeve 4.

The conventional probe pin 1 as such is fabricated according to the next process. First of all, the upper and lower contact parts 5, 6, coil spring 7 and the sleeve 4 (a state that both ends are not bent) are fabricated, respectively.

By drilling a pole-shaped material having constant width, the sleeve 4 as a tubular tube is fabricated.

As such, once the upper and lower contact parts 5, 6, coil spring 7 and the sleeve 4 are fabricated, the upper and lower body parts 8, 10 are inserted inside both ends of the sleeve 4 to be opposed between the coil spring 7 after inserting the coil spring 7 to the inside of the sleeve 4. After inserting, both ends of sleeve 4 are bent to the inside and the upper and lower contact parts 5, 6 are not deviated from the inside to the outside of the sleeve 4.

### DISCLOSURE

### Technical Problem

However, in the conventional probe pin, the sleeve as one component of the probe pin has very narrow inside diameter of 0.4 mm normally. Therefore, it needs to be drilled by normal drill machine for accurate processing, which requires long time to processing and results in lowering of productivity due to high fraction defective and rising of production cost.

In addition, the upper and lower contact parts and coil spring that inserted into the inside diameter of the sleeve should be imbedded inside the sleeve of 0.4 mm inside diameter. After imbedding, operations of round-cutting the upper and lower end portion of the sleeve to the inside should be executed in a separate way lest the upper and lower contact parts should be deviated to the outside, which results in remarkable drop of work efficiency.

Further, a stable electric signal is not transmitted but transmitted unstably according to deviation by the impedance value of each component since the upper and lower contact parts, sleeve and coil spring are comprised, which drops reliability of the test.

### Technical Solution

Therefore, it is an object of the invention to overcome the problems in the prior art technique, and to provide a probe pin for transmitting a stable electric signal between the external connecting ports that separated as appointed distance by sending the electric signal via a transmitting path with the impedance being unchanged. The probe pin comprising a sleeve, upper and lower contact parts, and a coil spring formed in one body may be fabricated automatically to improve productivity.

For fabricating the probe pin in the present invention, the die of the press is used as the means for achieving the objects.

Namely, when the press moves up and down once, one step is executed, hereinafter, once the press leaves a constant space, the operation for executing next step is performed repeatedly (progressive die), which enables to fabricate the product continually.

In detail, the upper and lower portions of the sleeve, coil spring, and the body and the like are moved at regular intervals to fabricate inside the die during repeated operation of the press. In the final step (process), every component with a fabricated state (finished product) is automatically discharged outside the die. Therefore, the production cost can be progressively reduced.

Especially, it is important to accommodate the probe pin made up of the element with superior electric characteristic and excellent elasticity and strength. It is preferable to use the component of gold-plated beryllium bronze alloy and beryllium nickel alloy currently, but if the element with electric features, elasticity and strength reinforced may be developed, it is needless to say such an element could be used in all ways.

### ADVANTAGEOUS EFFECTS

By fabricating the probe pin according to continual operation utilizing one die, the present invention provides the effect of reducing the fabricating time remarkably and lowering of the production cost due to needlessness of the fabricating time. In addition, by fabricating the probe pin in one body, mass production may be possible and it improves the electric characteristic.

### DESCRIPTION OF DRAWINGS

FIG. 1 is a cross sectional view illustrating the constitution of the prior probe pin.

FIG. 2 is a development view illustrating the constitution of the first embodiment in the probe pin of the present invention.

FIG. 3 is a longitudinal sectional view of assembly view of the first embodiment in FIG. 2.

FIG. 4 is a lateral cross sectional view of the first embodiment in FIG. 3.

FIG. 5 is a perspective view illustrating the states before the elastic spring part as the core of the present invention is molded to the coil spring.

FIG. 6 is a perspective view illustrating the states in that the elastic spring part as the core of the present invention is molded to the coil spring.

FIG. 7 is a development view illustrating the constitution of the second embodiment.

FIG. 8 is a front view illustrating the constitution of the second embodiment.

FIG. 9 is a development view illustrating the constitution of the third embodiment.

FIG. 10 is a perspective view illustrating the assembled states of the third embodiment.

FIG. 11 is a cross sectional view illustrating the constitution of the third embodiment.

FIG. 12 is a development view illustrating the constitution of the forth embodiment.

FIG. 13 is a perspective view illustrating the assembled constitution of the forth embodiment.

FIG. 14 is a cross sectional view illustrating the constitution of the forth embodiment.

FIG. 15 is a development view illustrating the constitution of the fifth embodiment.

FIG. 16 is a perspective view illustrating the constitution of the fifth embodiment.

FIG. 17 is a cross sectional view illustrating the constitution of the fifth embodiment.

FIG. 18 is a development view illustrating the constitution of the sixth embodiment in the present invention.

FIG. 19 is a cross sectional view of the sixth embodiment in the present invention.

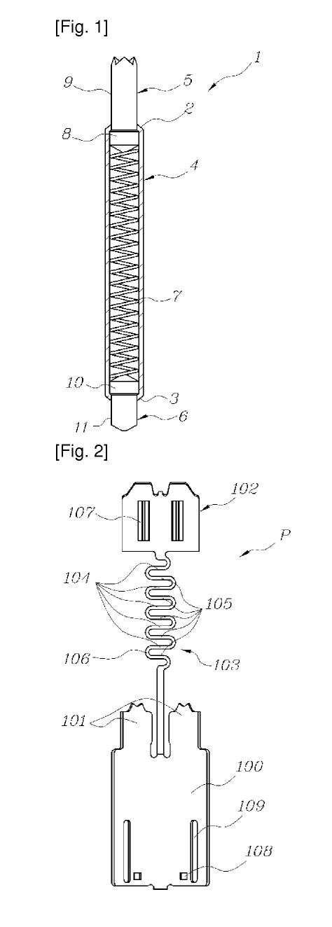

### BEST MODE

Hereinafter, the present invention will be described with reference to the accompanying drawings.

The fabricating method of a probe pin in the present invention comprising, cutting a body so that an upper contact part 101, a lower contact part 102, and an elastic spring part 103 may be formed in one body 100; burning a coil spring 106 for an elastic spring part 103 to have the elastic force; molding a lower port for a lower contact part 102 to be formed roundly; bending the elastic spring part 103 to the inner side of the body 100; finishing that the upper contact part 101 may be rolled smaller than an external diameter of the body 100 and projected after molding the body 100 roundly.

Further, there is a little difference in the burning step of the present invention according to whether the lower contact part 102 can have the elastic force by determining how to burn the elastic spring part.

And the body 100 and the lower contact part 102 can be formed in a circular or square shape according to the shape of the elastic spring part 103 positioned inside the body.

Reference will now be made in detail to the preferred embodiments of the present invention, examples of which are illustrated in the accompanying drawings.

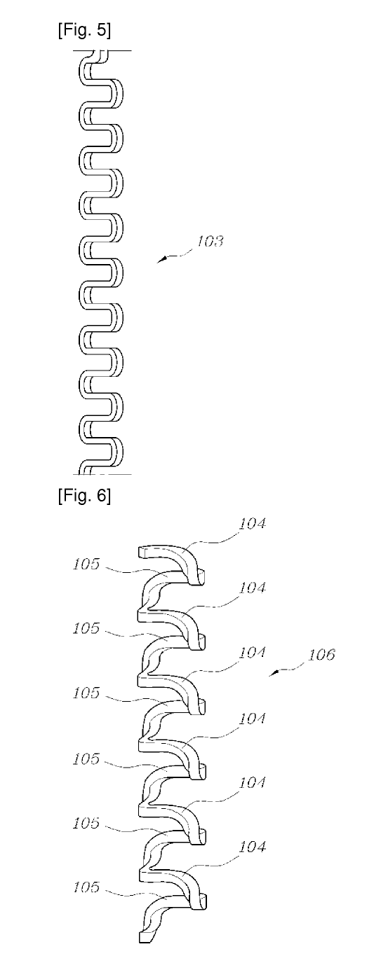

FIG. 2 to 5 illustrate the first embodiment for realizing the present invention. FIG. 2 is a development view for realizing the first embodiment of the present invention where the upper and lower contact parts 101, 102 and the elastic spring part 103 are formed in one body 100.

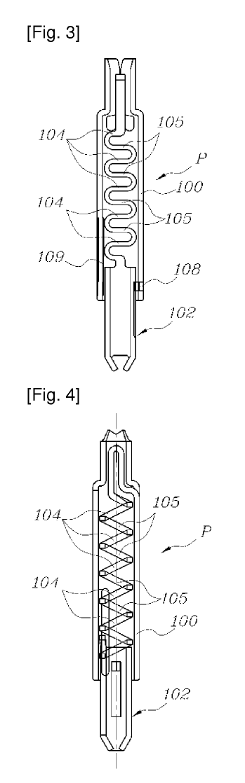

Then, as shown in FIG. 6, the A compression part 104 is plastic deformed to the upper portion, and B compression part 105 is plastic deformed to the lower portion for giving the elastic force, for the elastic spring part 103 consists of a plate merely. The elastic spring part is fabricated in a shape of a coil spring 106 to contain elastic features, as shown in FIG. 3, then the elastic spring part 103 is bent to the inner side of the body 100 in the state that the lower contact part 102 is molded roundly, and molding the body 100 roundly, then the lower contact part 102 is projected to the outside of the body 100 to form the probe pin P.

At that time, the means for fixing the stroke of the lower contact part 102 is constituted, however, a protrusion 108 is movable within a depressed groove 107 merely to be capable of adjusting the stroke by forming the protrusion 108 in the body 100 and the depressed groove 107 in the lower contact part 102.

Instead of forming the depressed groove 107 and protrusion 108 apart, it is realized by compressing the part corresponding to the depressed groove 107 and protrusion 108.

With this fabricating method, the probe pin has same impedance for it is integrally formed and thereby the elastic characteristic is superior. The probe pin fabricated with above mentioned method of the present invention comprises the upper and lower contact parts 101, 102, and the elastic spring part 103 in one body 100.

The elastic spring part 103, the one end of which includes a shape of coil spring 106 connected to the body 100, and the lower contact part 102 is formed in one body at the end of the elastic spring part 103. Further, the lower contact part 102 by the protrusion 108 is movable upward and downward within the length of the depressed groove 107 merely to be capable of adjusting the stroke since the depressed groove 107 is formed at the pillar side of the lower contact part 102 and the protrusion 108 is formed in the body 100.

The probe pin in the present invention, like the conventional probe pin, may be supplied as each probe pin, and can be supplied in a manner of a reel-type for it is fabricated by a die, which results in cost down and quality improvement by using automatic inserting machine to realize automation of socket production.

When a port of the power source contacts with the lower contact part 102 for turning on the electricity, the lower contact part 102 absorbs the shock in slightly compressing by contacting force while the electricity flows via the lower contact part 102, the coil spring 106, and the upper contact part 101 flowing inner side of the body 100 to turn on the electricity.

At that time, even though the electricity flows via the coil spring 106, the electric resistance may be minimized since the electricity is promptly on via the body.

When the lower contact part 102 having elasticity into the inner side of the body 100 is slid, the protrusion 109 plays a role as the electric path to maintain constant resistance value while maintaining constant pressure by contacting with the inner side of the body 100.

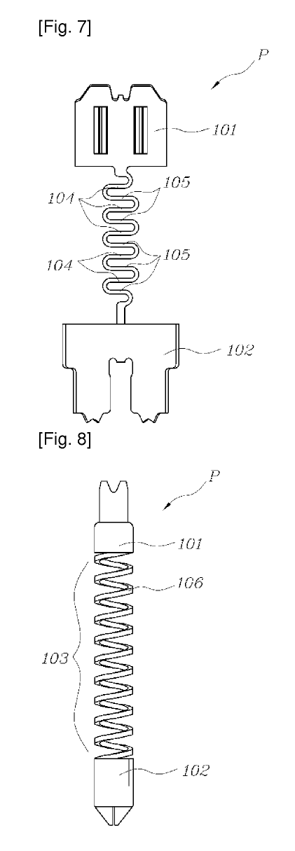

FIG. 7 to 8 illustrate the second embodiment of the present invention where the upper and lower contact parts 101, 102 and the elastic spring part 103 are formed in one body 100.

Then, the A compression part 104 is plastic deformed to the upper portion, and B compression part 105 is plastic deformed to the lower portion for giving the elastic force, for the elastic spring part 103 consists of a plate (blanking) when operating initially, as shown in FIG. 6. The elastic spring part 103 is fabricated in a shape of a coil spring 106 to contain elastic features, as shown in FIG. 8, then the lower contact part 102 and the upper contact part 101 are rolled roundly, to form the probe pin P.

It shows that the electricity is on via the upper contact part 101 and coil spring 106 when the probe pin turns on via the lower contact part 102. In here, the shapes of the upper and lower contact parts 101,102 may be fabricated in various shapes such as a circular or bending shape. The stopper function required in fabricating the socket may be accommodated.

The second embodiment of the present invention is applicable to the needle pin of the probe card or the probe pin when in fabricating the minimum diameter (40-200 micron) of probe pin since the body part 100 in FIG. 3 to 5 of the first embodiment can not be seen in the second embodiment.

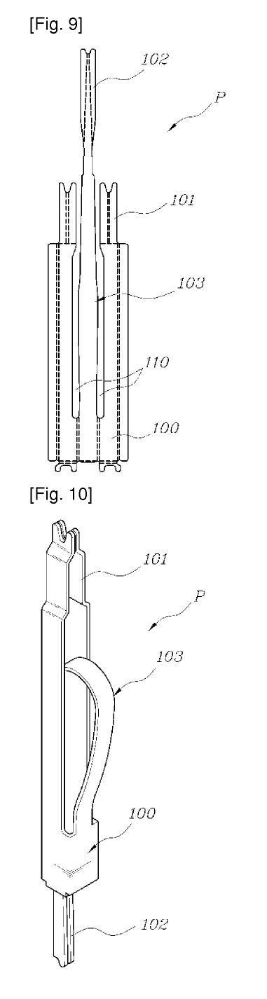

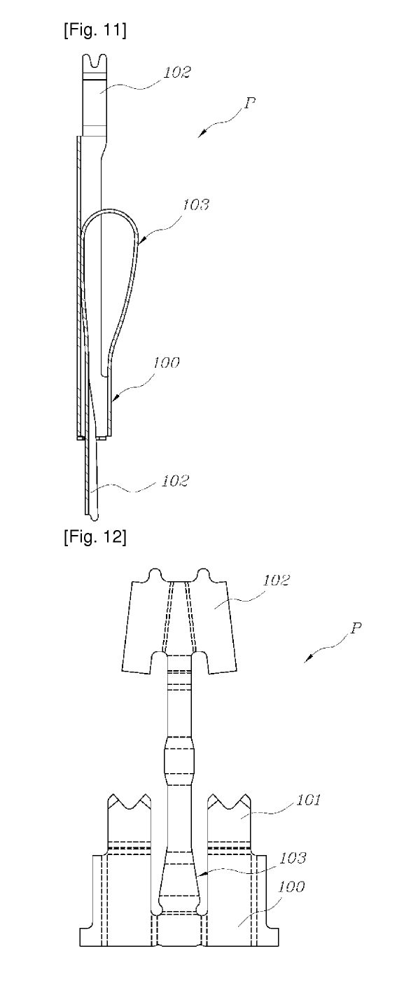

FIG. 9 to 11 illustrate the third embodiment of the present invention where the upper and lower contact parts 101, 102 and the elastic spring part 103 are formed in one body 100.

Two blanking parts 110 for fabricating the elastic spring are formed in the body 100, and the elastic spring part 103 begins at which the blanking parts 110 are finished, still the lower contact part 102 is formed in one body at the tip of the elastic spring part 103.

The elastic spring part 103 forming a plate is made up of roundly so that the lower contact part 102 may be positioned in the reverse direction with the upper contact part 101 like FIG. 10 appended, in a state that the lower contact part 102 is contacted with printed circuit board (PCB) part.

Strictly speaking, the elastic spring brings about an effect of the coil spring and plane spring.

In the probe pin P of the present invention, the contact part of the upper portion 101, the contact part of the lower portion 102, and the elastic spring part 103 are comprised in one body 100. And an end of the elastic spring part 103 includes a shape of a plate in FIG. 9 connected to the body 100, and the elastic spring part 103 is molded roundly from the bottom face of the body. In addition, the external part of molded portion in the elastic spring part 103 is adjoined to the internal face of the body 100 to turn on the electricity.

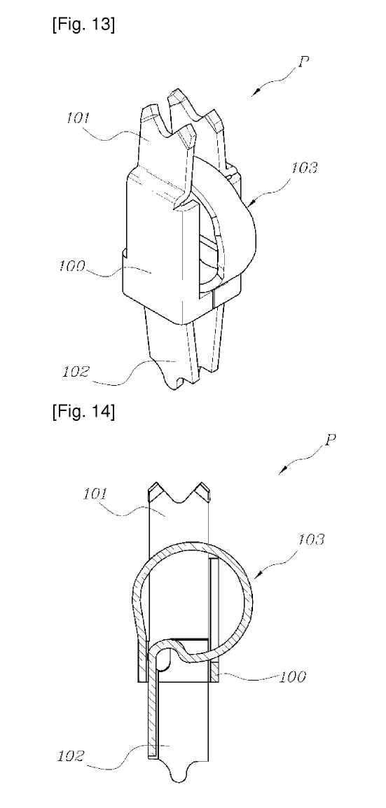

FIG. 12 to 14 being attached are the forth embodiment illustrating a modifying example of the third embodiment in the present invention, in the case of a small probe pin for high-speed under 1.5 mm in length of the probe pin, the elastic spring part 103 for reinforcing the elastic force is molded roundly in the same manner as for the third embodiment but merely different in view of the current flow. When a power source from the contact part of the lower portion 102 in FIG. 14 is supplied, a side face of the top in the elastic spring part 103 contacts with a internal face of a wing-shape in the contact part of the upper portion 101 to turn on the electricity.

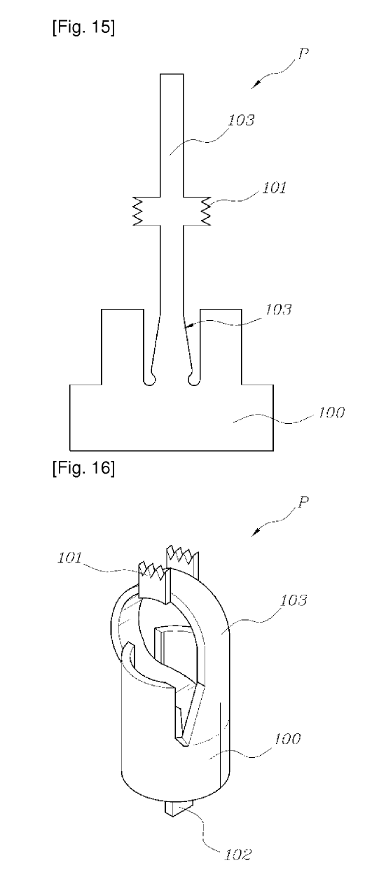

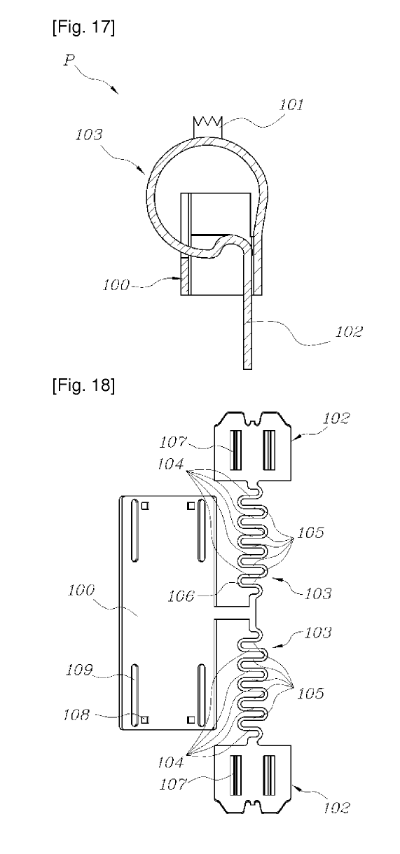

FIG. 15 to 17 being attached are the fifth embodiment illustrating a another modifying example of the third embodiment in the present invention, the upper and lower contact parts 101, 102, and elastic spring part 103 are formed in one body 100. The power supply linked to the lower contact part 102 is transferred to the upper contact part 101 via the elastic spring part 103.

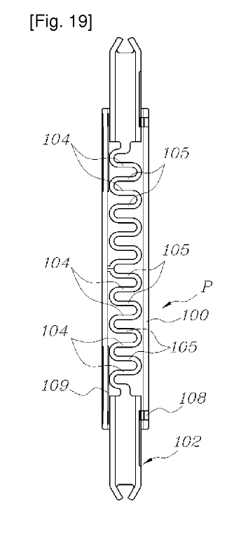

FIG. 18 to 19 illustrates the sixth embodiment of the present invention, wherein the elastic spring part 103 formed on the body 100 comprises the upper and lower contact parts 101, 102. At this time, the elastic spring part 103 forms the shape of character S, or may be formed roundly.

In the present invention, the body 100, the upper and lower contact parts 101, 102, and elastic spring part 103 are formed in one body, which results in a superior electric characteristic. Further, it provides the superior elastic force due to the elasticity of the elastic spring part 103 wholly coupled to the lower contact part 102. And the fabricating time is shortened as well as mass production is possible by using the die.

### MODE FOR INVENTION

### Industrial Applicability

The probe pin of the present invention can be applied to all the probe pins being widely used in the semi-conductor test or PCB (Printed Circuit Board) test of electronic products currently. Further, as the product delivery and mass production of equal quality is possible, the problems of limitation of mass production by manual production and the =difficulty of world standardization due to unequal quality are solved, which brings about universal standardization. Especially, market entry of the test socket for BGA, test socket for LGA and memory module test is possible by low cost of fabricating the probe pin since that was difficult to enter the market because of high price of probe pin. Also, minimum diameter of the probe pin in the present invention enables fabricating of the probe pin of at least 40 micron while it was impossible to make at least 100 micron diameter of probe pin by the prior system, which enables to apply to the needle pin of the probe card or the probe pin for affecting on the probe card market.

### SEQUENCE LIST TEXT

upper contact part, lower contact part, elastic spring part, coil spring, depressed groove, hook jaw, protrusion

1. A method of fabricating an integrally formed probe pin comprising, cutting a body so that an upper contact part, a lower contact part, and an elastic spring part may be formed in one body; burning a coil spring for an elastic spring part to have the elastic force; molding a lower port for a lower contact part to be formed roundly; bending the elastic spring part from the top to the bottom in the inner side of the body; finishing that the upper contact part may be rolled smaller than an external diameter of the body and may be projected to contact the port of P.C.B. or the semi-conductor after molding the body roundly.

2. A method of fabricating an integrally formed probe pin comprising, cutting a body so that an upper contact part, a lower contact part, and an elastic spring part may be formed in one body; burning a coil spring for an elastic spring part to have the elastic force; molding a lower port for a lower contact part and an upper contact part to be formed roundly; bending the elastic spring part from the lateral side to the inside of the body; finishing the body to mold after forming the body roundly.

3. The method of fabricating an integrally formed probe pin according to claim 1, wherein the elastic spring part is cut in the shape of wave (character S) in the cutting step, and A compression part is plastic deformed to the upper portion, and B compression part is plastic deformed to the lower portion for giving the elastic force, in the burning step.

4. The method of fabricating an integrally formed probe pin according to claim 1, wherein the protrusion is molded in the body, and the depressed groove in the upper and lower contact parts, or the depressed groove is molded in the lower contact part merely in the cutting step, when the body is cut.

5. The method of fabricating an integrally formed probe pin according to claim 1, wherein the elastic spring part may be cut in the shape of slim and long plate, and the lower contact part may have the elastic force by rolling the upper part of the elastic spring in the molding step.

6. The method of fabricating an integrally formed probe pin according to claim 1, wherein the body is molded so that the upper and lower contact parts, may be formed in a square or circular shape, regardless of a square or circular or oval in a roundly rolled shape like a coil spring for finished shape of the coil spring.

7. An integrally formed probe pin characterized in that an upper contact part is formed in the upper portion of the body, and the body comprises a lower contact part formed with an elastic spring part in one body and the elastic spring part connected to one end of the body, and the elastic spring part is positioned inside the body so that the lower contact part may be projected to the lower part of the body.

8. The probe pin according to claim 7, wherein the elastic spring part is formed in the shape of the coil spring connected to the body.

9. The probe pin according to claim 7, wherein the elastic spring part with a shape of slim and long plate is roundly molded in the portion connected to the body so that the lower contact part may have the elasticity.

10. The probe pin according to claim 7, wherein the lower contact part the protrusion is movable upward and downward within the length of the depressed groove merely to be capable of adjusting the stroke since the depressed groove is formed at the pillar side of the lower contact part, and the protrusion is formed in the body.

11. The probe pin according to anyone of claims 7 to 8, wherein the body, and the upper and lower contact parts, are formed in a shape of a square.

12. The probe pin according to claim 8, wherein a part of roundly formed portion in the elastic spring part is adjacent to the inner face of the body.

13. The probe pin according to claim 8, wherein both sides of roundly formed portion in the elastic spring part are projected to the outside of the body.

14. An integrally formed probe pin characterized in that an upper contact part is formed in the upper portion of the body, and the body comprises a lower contact part formed with an elastic spring part in one body and the elastic spring part connected to one end of the body, and the elastic spring part is a shape of a coil spring.

15. The probe pin according to claim 14, the upper and lower contact parts, are inclined or bent to the inner side that the end portion may be matched.

16. An integrally formed probe pin characterized in that when the lower contact part having elasticity into the inner side of the body is slid, the protrusion plays a role as the electric path to maintain constant resistance value while maintaining constant pressure by contacting with the inner side of the body.

17. The probe pin according to claim 14, wherein the upper and lower elastic spring part are formed in the center of the body, and the upper contact part and lower contact part are formed in the both ends of the elastic spring part so that the upper and lower contact parts may have the elasticity.
